(19) United States
(12) Patent Application Publication
(10) Pub. No.: US 2004/0240063 A1
(43) Pub. Date: Dec. 2, 2004

(54) Method of creating a controlled flat pass band in an echelle or waveguide grating

(76) Inventors: Andre Delage, Ontario (CA); Muthukumaran Packirisamy, Ottawa Ontario (CA); Siegfried Janz, Ottawa Ontario (CA); Lynden Erickson, Cumberland Ontario (CA); Dan-Xia Xu, Gloucester Ontario (CA); Pavel Cheben, Ottawa Ontario (CA); Boris Lamontage, Ottawa Ontario (CA); Sylvain Charbonneau, Cumberland Ontario (CA)

Correspondence Address: MARKS & CLERK, P.O. BOX 957, STATION B, OTTAWA, ON, K1P 5S7, CA

(21) Appl. No.: 10/478,964

(22) PCT Filed: May 28, 2002
(86) PCT No.: PCT/CA02/00783

(30) Foreign Application Priority Data
May 28, 2001 (CA) 2,349,034

(51) Int. Cl. G02B 5/18

(52) U.S. Cl. 359/571

(57) ABSTRACT

A method is desribed for controlling the pass band of an optical device wherein a phase mask is introduced to modify the shaped of an image produced by the photonic device.

### BACKGROUND OF THE INVENTION

1. Field of the Invention

This invention relates to the field of photonics, and more particularly to a method of creating a controlled flat pass band in an photonic device such as an echelle or waveguide grating.

2. Description of the Related Art

Multiplexers/demultiplexers are used in wavelength division multiplex systems to respectively combine and separate individual wavelengths carrying optical signals. It is know that MUX/DEMUX devices can be either arrayed waveguide devices or gratings, such as echelle gratings, wherein a slab waveguide directs incoming light onto the facets of the diffraction grating. In the case of a DEMUX, the output wavelengths are carried off by individual waveguides.

The optical response of a grating describes the detection efficiency of a signal at a given wavelength; in a MUX/DEMUX this definition applies to each output waveguides that are used as detectors.

A flat passband in the response of a MUX/DEMUX is needed in the world of optical WDM (wavelength division multiplex) telecommunications in case a given channel is not emitting at its precise nominal value. For example, the response of one channel must be inside 1 dB for a range of 14 nm of each side of the nominal wavelength (35 GHz for 100 GHz spacing channels).

There are fundamentally two known approaches for increasing the flatness of the response of a DEMUX made of one echelle grating or arrayed waveguide (AWG). The first approach consists in modifying the structure of the entrance and output waveguides to make them multimode. This technique includes using wider waveguides, a multimode interference coupler, larger step index and tapers etc. The second family of techniques concentrates on the grating itself. Two interleaved gratings tuned at slightly different wavelengths have already been proposed: Dragone, C., T. Strasser, G. A. Bogert, L. W. Stulz and P. Chou., ‘Waveguide grating router with maximally flat passband produced by spatial filtering’, Electronics Letter, September 1997, 33, 15, 2, pp. 1312-1314 disclose the use of a spatial filtering function that includes zeros in order to provide sharp response discontinuity where high channel isolation is needed; Okamoto, K. and H. Yamada, ‘Arrayed Waveguide grating multiplexer with flat spectral response’, Optics Letter, January 1995, Vol. 20, No.1, pp. 43-45 describe a filter calculated by inverse Fourier transform, in which the position of the grating waveguides (equivalent to the facets in our case) is changed by ½ where the filter function is negative; a very flat response is predicted with a loss of 1 dB.

Cascading gratings of different resolving power have also been used, but they are of much larger size.

Present techniques have a number of drawbacks. When only the width is changed, the flatness does not provide abrupt filter edges since the tail depends mostly on the index step. Also, the use of a multimode waveguide at the input can be detrimental to the cross-talk. On the other hand locally changing the index step is quite involved for the fabrication process. A double grating has no abrupt edges, which means increasing the cross-talk for a given geometry (size).

Generally, the published spatial filter results do not meet mux/demux specifications for cross-talk.

### SUMMARY OF THE INVENTION

According to the present invention there is provided a method of controlling the passband of an optical device comprising introducing a phase mask to modify the shape of an image produced by the optical device. Preferably, the phase mask is provided by deliberately displacing the facets of a grating relative to their normal positions in accordance with a predetermined law, although other forms of phase mask could be employed.

The invention is based on a holography approach in which a phase mask is introduced to modify the shape of an image. It is known that Gaussian laser beams can be changed into cylindrical beams by diffractive elements to improve the power distribution of a laser welding machine. Even ring-shaped distributions have been proposed and theoretically demonstrated.

In the present invention the introduction of a phase mask is equivalent to modifying the position of the facets of a grating by one wavelength to cover the entire phase range required. Preliminary mathematical experiments have demonstrated the validity of the approach by introducing a simple lens function by displacing slightly the facet positions of the diffraction grating. One example of a phase mask is described, for example, in U.S. Pat. No. 5,840,622, the contents of which are herein incorporated by reference.

The invention essentially provides a Fresnel lens. The quality of the re-focused spot does not deteriorate when the phase change remains into the first zone, limiting the displacement to approximately one wavelength (±λ/2).

The positions of the facet can be adjusted in order to meet specific requirements in the spot shape, requirements chosen to produce the desired flatness in the response. Minimisation results showed an obvious trend indicating that the facet displacements are regularly distributed according a simple power law with alternating displacement direction. A systematic study of the exponent of the power law and the maximum displacement shows that the principal characteristics of the bandpass (insertion loss, width at 1, 3 and 20 dB, as well as the X-talk) follow well defined regular behaviour with a full predictability.

In another aspect the invention provides a photonic device comprising a phase mask to modify the shape of an image produced thereby. The phase mask is preferably formed by displacing the facets of a grating from their normal positions in accordance with a predetermined law.

### BRIEF DESCRIPTION OF THE DRAWINGS

The invention will be now described in more detail, by way of example only, with reference to the accompanying drawings, in which;

FIG. 1 is a schematic diagram of an echelle grating; and

FIG. 2 shows the theoretical response of a grating of with and without the flattening filter in accordance with the invention.

### DETAILED DESCRIPTION OF THE INVENTION

The invention will be described with reference to an echelle grating. An echelle grating, as is known in the art, typically has a slab waveguide providing an input, and a plurality of reflecting facets, which diffract incident light back along a path dependent on wavelength. Output waveguides receive the separated wavelengths. In conventional echelle grating, the facets are uniformly spaced.

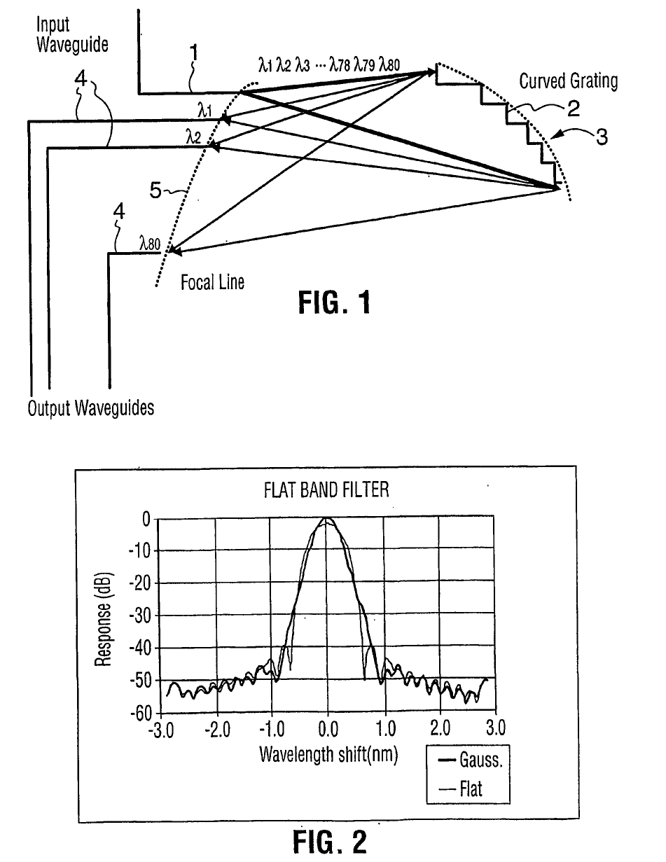

In FIG. 1, an input waveguide 1 carrying component wavelengths λ₁, λ₂, . . . λₙ directs the light onto facets 2 of echelle grating 3. The output signals are extracted by discrete ridge output waveguides 4. Preferably the echelle grating is based on a Rowland circle design, and the output waveguides 4 are arranged on the focal line 5. In a conventional grating the facets 2 are uniformly spaced.

In accordance with the principles of the invention, in order to create a phase mask, the facets are slightly displaced. Facet displacements are given according to the equation:

Δxᵢ=(−1)ⁱδₘₐₓ·|i−i_{CENTRE}|ⁿ

where δₘₐₓ (the maximum displacement) and n are the two parameters that define the flatness of the response and the other characteristics of the filter (Cross-talk, insertion loss and background). The i−i_{centre} represents number of facets between the i^{th} facet2 and the centre facet i_{centre}.

In general δₘₐₓ must be smaller than the wavelength and n should be in the range of 1.5 to 3.0 (not limited to an integer). Larger values of δₘₐₓ increase the flattening effect. An exponent n of around 1.5 tends to split the grating image into two peaks of equal intensity, producing a large flat but with a penalty of 3 dB.

An increase in the parameter n makes these two contributions closer and closer, improving the insertion loss, but decreasing the width of the flatness band. Variation of these two parameters allows the response to be tuned to any specification in an appropriate range. Extensive modelling tests indicate that the background (cross-talk with far channels) does not deteriorate when the facet are distributed according in equation 1. Cross-talk to the next neighbour is usually improved since the stiffness of the slope of the response increases but obviously too large flatband may interfere with the next channel.

An example with δₘₐₓ=0.25 μm and n=1.7 is shown in FIG. 2. In this case the Gaussian and flat response are compared. Insertion loss due to diffraction (scalar theory) increases by ˜2 dB from 0.3 to 2.2. Although not absolutely flat, the response of the Flat curve exceeds the Telecordia specifications for 1 dB with a width of 0.30 nm or 37.5 GHz.

For mux/demux the next channels are located at ±0.8 nm where the theoretical response is particularly low. This technique opens the way to tailoring particular features in the response by modifying only slightly the position of the facets.

The invention thus alleviates the problems of the prior art, and in the described embodiment the displacement of the facets provides a very effective way of providing a phase mask. The invention also permits the direct predictability of the performance from simple laws.

1. A method of controlling the passband of a photonic device comprising introducing a phase mask to modify the shape of an image produced by the optical device.

2. A method as claimed in claim 1, wherein said optical device includes a diffraction grating, and wherein said phase mask is formed by displacing the position of the facets from a regular spacing in accordance with a predetermined law.

3. A method as claimed in claim 2, wherein said facets are displaced by an amount Δxᵢ in accordance with the equation:
Δxᵢ=(−1)ⁱδₘₐₓ·|i−i_{CENTRE}|ⁿ
where δₘₐₓ and n are the two parameters that define the flatness of the response.

4. A method as claimed in claim 3, wherein said diffraction grating is an echelle grating.

5. A method as claimed in claim 4, wherein said echelle grating is based on a Rowland circle.

6. A method as claimed in claim 3, wherein δₘₐₓ is about 0.25 μm and n is about 1.7.

7. A photonic device comprising a phase mask to modify the shape of an image produced thereby.

8. A photonic device as claimed in claim 7, wherein said optical device includes a diffraction grating, and wherein said phase mask is formed by displacing the position of the facets from a regular spacing in accordance with a predetermined law.

9. A photonic device as claimed in claim 8, wherein said facets are displaced by an amount Δxᵢ in accordance with the equation:
Δxᵢ=(−1)ⁱδₘₐₓ·|i−i_{CENTRE}|ⁿ
where δₘₐₓ and n are the two parameters that define the flatness of the response.

10. A photonic device as claimed in claim 9, wherein said diffraction grating is an erhelle grating.

11. A photonic device as claimed in claim 10, wherein said echelle grating is based on a Rowland circle.

12. A photonic device as claimed in claim 9, wherein δₘₐₓ is about 0.25 μm and n is about 1.7.
